(19) United States
(12) Patent Application Publication
(10) Pub. No.: US 2008/0308158 A1
(43) Pub. Date: Dec. 18, 2008

(54) Pump Head with Improved Structure

(76) Inventor: Scott Wu, Wu Feng Hsiang (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/834,245

(22) Filed: Aug. 6, 2007

(30) Foreign Application Priority Data
Jun. 12, 2007 (TW) 96121162

(51) Int. Cl. F04B 33/00; B60S 5/04; F16K 15/20; F16L 37/05

(52) U.S. Cl. 137/231

(57) ABSTRACT

A pump head with improved structure includes a lever pivotally mounted thereto. A plunger is installed in the pump head and includes a recessed portion formed around the outer periphery thereof and a sealing member receivable at the outer periphery thereof for preventing air from passing therethrough. A first anti-backflow member is also installed in the pump head and is mounted on the outer periphery of the plunger for allowing a flow of the air in one direction. An air induction member is installed in the pump head and rests on the plunger in the longitudinal direction of the plunger. A seal gasket is also installed in the pump head and rests on the air induction member in the longitudinal direction of said air induction member.

### BACKGROUND OF THE INVENTION

1. Field of the Invention

The present invention relates to an air pump head.

2. Description of the Related Art

A portable bicycle pump and its associated pump head are typically small in size so as to be carried on a bicycle conveniently and to keep the overall weight as light as possible. However, there are several problems associated with manufacturing of such a pump. A first problem is that components receivable in the pump head have to be small in size while attaining a satisfactory degree of tolerance in order to completely prevent leakage of the pumped air from happening, but since the components are generally molded by injection molding from plastic material which have a tendency to shrink away form the mold during cooling, the components are, therefore, easy to cause leakage of the pumped air. Thus, in order to precisely make these components, the cost of manufacture will be increased. Another problem is that the manufacturing of these components may involve many processes. A further problem is that the assembly of the components could be troublesome.

The present invention is, therefore, intended to obviate or at least alleviate the problems encountered in the prior art.

### SUMMARY OF THE INVENTION

A pump head with improved structure includes a lever pivotally mounted thereto. A plunger is installed in the pump head. The plunger includes a recessed portion formed around the outer periphery thereof and a sealing member receivable at the outer periphery thereof for preventing air from passing therethrough. A first anti-backflow member is also installed in the pump head and is mounted on the outer periphery of the plunger for allowing a flow of the air in one direction. An air induction member is installed in the pump head and rests on the plunger in the longitudinal direction of the plunger. A seal gasket is also installed in the pump head and rests on the air induction member in the longitudinal direction of said air induction member. A cap is mounted to the pump head for enclosing the plunger, the first anti-backflow member, the air induction member and the seal gasket in the pump head.

It is one aspect of the invention that the first anti-backflow member is adapted to prevent leakage of the pumped air from happening.

It is another aspect of the invention that the first anti-backflow member is adapted to allow a greater tolerance margin for manufacturing the pump head and easy installation thereof.

It is yet another aspect of this invention that the first anti-backflow member is adapted to allow the cost of manufacturing the pump head to be cut down.

Other objectives, advantages, and novel features of the invention will become more apparent from the following detailed description when taken in conjunction with the accompanying drawings.

### BRIEF DESCRIPTION OF THE DRAWINGS

For the present disclosure to be easily understood and readily practiced, the present disclosure will now be described for the purpose of illustration not limitation, in conjunction with the following figures, wherein;

FIG. 1 is a perspective view of an air pump including a pump head embodying the present invention.

FIG. 2 is exploded view of the pump head shown in FIG. 1.

FIG. 3 is a cross-sectional view taken along line 3-3 of FIG. 1.

FIG. 4 is a partial, enlarged view of FIG. 3.

FIG. 5 is a cross-sectional view illustrating the air is pumped into the pump head, with the arrows indicating direction of air flow.

FIG. 6 is a partial, enlarged view of FIG. 5.

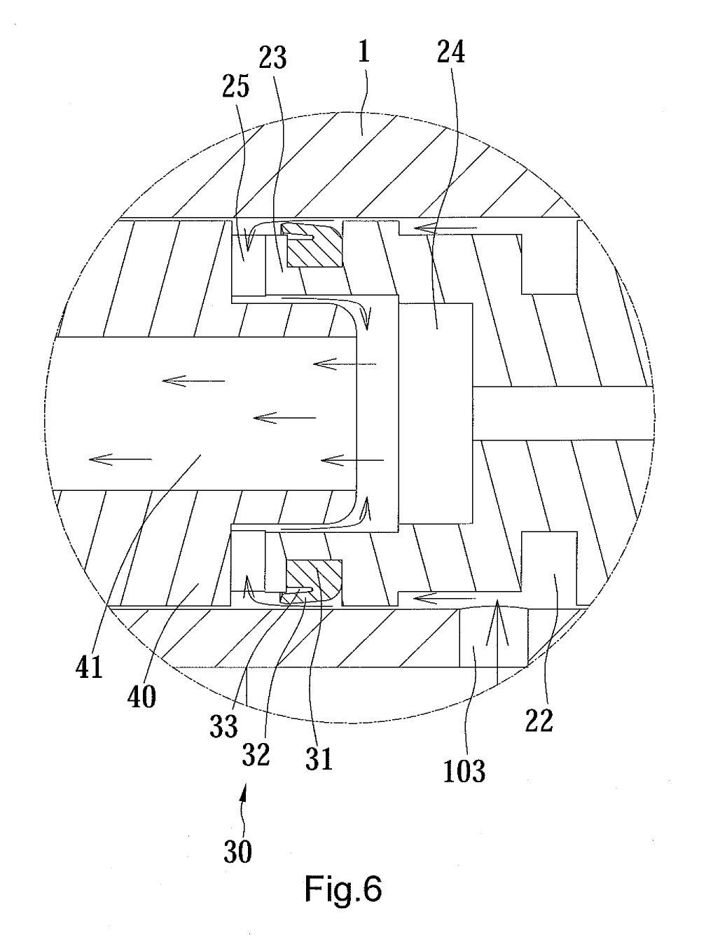

FIG. 7 is another embodiment of the pump head embodying the present invention.

FIG. 8 is yet another embodiment of the pump head embodying the present invention.

### DETAILED DESCRIPTION OF THE PREFERRED EMBODIMENT

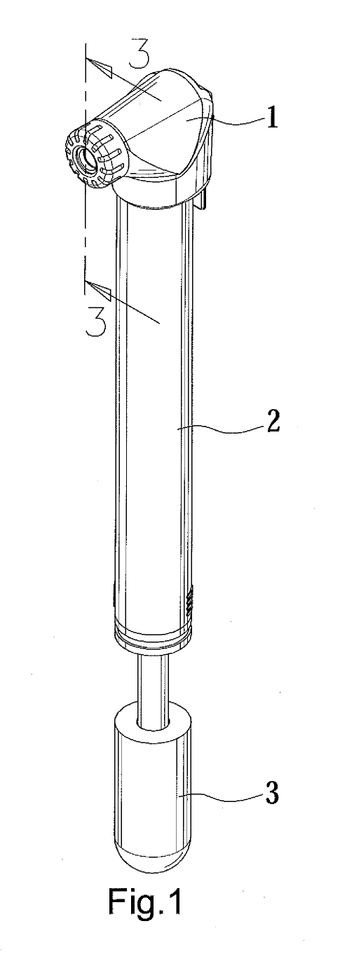

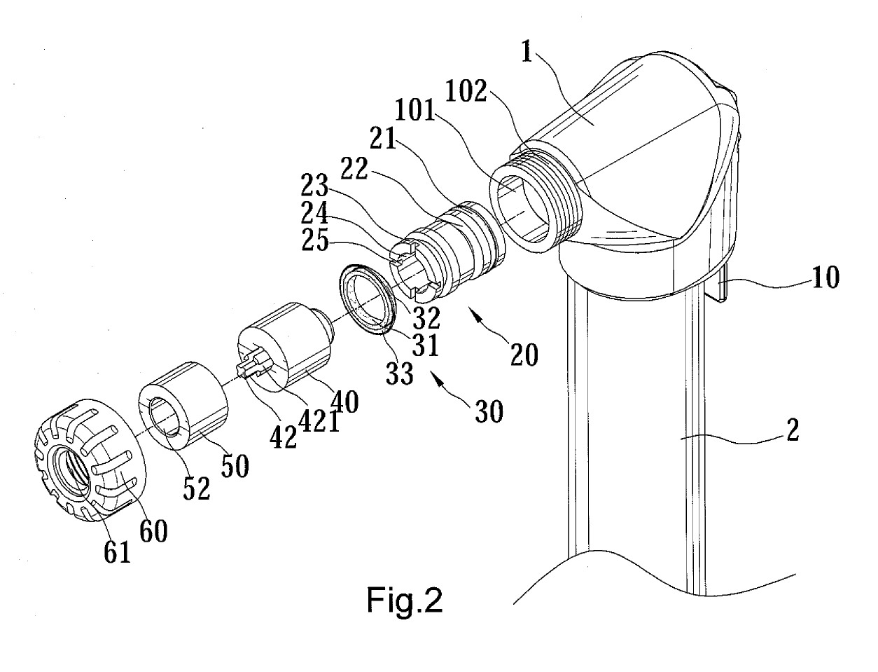

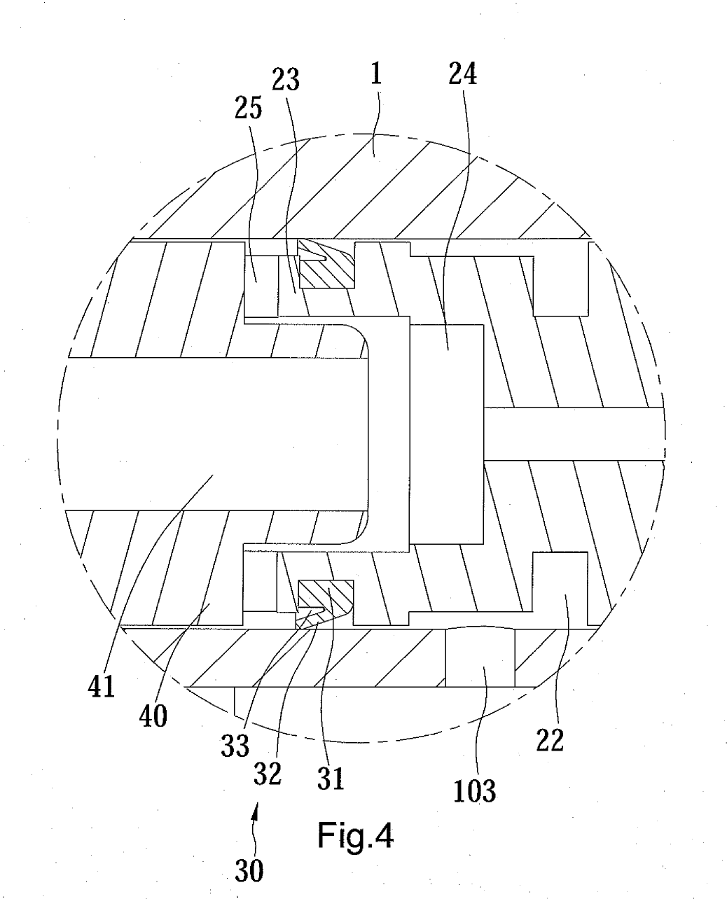

Referring to FIGS. 1 through 4, a pump head 1 with improved structure includes a cylindrical body 2 connected thereto and an inflating member 3 receivable in the cylindrical body 2. The cylindrical body 2 defines an air chamber 202 and includes valve 201 disposed therein. The inflating member 3 includes a inflating valve 301 adapted to operably move within the cylindrical body 2, and by reciprocatingly moving the inflating member 3 within the cylindrical body 2 air is pumped from the cylindrical body 2 into the pump head 1 through an air-inlet hole 103.

The pump head 1 includes a compartment 101 which is adapted to receive a plunger 20, a first anti-backflow member 30, an air induction member 40 and a seal gasket 50. The first anti-backflow member 30 is mounted on the outer periphery of the plunger 20. The air induction member 40 rests on the plunger 20 in the longitudinal direction of the plunger 20. The seal gasket 50 rests on the air induction member 40 in the longitudinal direction of the air induction member 40. The pump head 1 also includes a threaded portion 102 formed thereof for engaging with a cap 60. The cap 60 includes a threaded portion 61 which engages with the threaded portion 102 of the pump head 1 in a complement manner. The cap 60 is adapted to confine the plunger 20, the first anti-backflow member 30, the air induction member 40 and the seal gasket 50 within the compartment 101 of the pump head 1. Furthermore, the pump head 1 includes a lever 10 pivotally connected thereto for operably urging the plunger 20 and consequently urging the first anti-backflow member 30, the air induction member 40 and the seal gasket 50.

The plunger 20 includes a recessed portion 22 formed around the outer periphery thereof adapted for fluid communication with the air-inlet hole 103. A sealing member 21 is also mounted on the outer periphery of the plunger 20 and is located intermediate the recessed portion 21 and the lever 10. The sealing member 21 is adapted for preventing air from passing therethrough. In this embodiment, the sealing member 21 is disclosed as an O-ring. Furthermore, the plunger 20 includes an air-inlet end 23 having a plurality of indentation 25 formed thereon and a cavity 24. The cavity 24 extends from the air-inlet end 23 in the longitudinal direction of the plunger 20 and is adapted for fluid communication with the plurality of indentations 25.

The first anti-backflow member 30 is mounted on the outer periphery of the plunger 20, more specifically, the first anti-backflow member 30 is located intermediate the recessed portion 22 and the air-inlet end 23. The first anti-backflow member 30 is adapted to allow a flow of air in one direction. The first anti-backflow member 30 is comprised of a body 31, a fin 32 which is integrally formed with the body 31. The body 31 is adapted for mounting on the outer periphery of the plunger 20. The fin 32 extends circumferentially around and inclinedly outward from one end of the body 31 and defines a gap 33 between the fin 32 and the other end of the body 31. Furthermore, the fin 32 extends from the body 31 until it touches the boundary wall of the compartment 101. The first anti-backflow member 30 is mounted to the plunger 20 with the fin 32 extending towards the air-inlet end 23. Moreover, the gap 33 is adapted to allow the fin 32 to be compressed toward the body 31 by air.

The air induction member 40 includes an end having an engaging pin 42 formed thereof for engaging with a valve (not shown) and another end receivable in the cavity 24 of the plunger 20. The air induction member 40 also has a bore 41 extending therethrough. The bore 41 is adapted for fluid communication with the cavity 24. Furthermore, the engaging pin 42 includes a plurality of cutouts 421 in communication with the bore 41.

The seal gasket 50 includes a first hole 51 adapted for receiving a valve (not shown) and a second hole 52 adapted for partially receiving the engaging pin 42. The first hole 51 and the second hole 52 are in communication with each other.

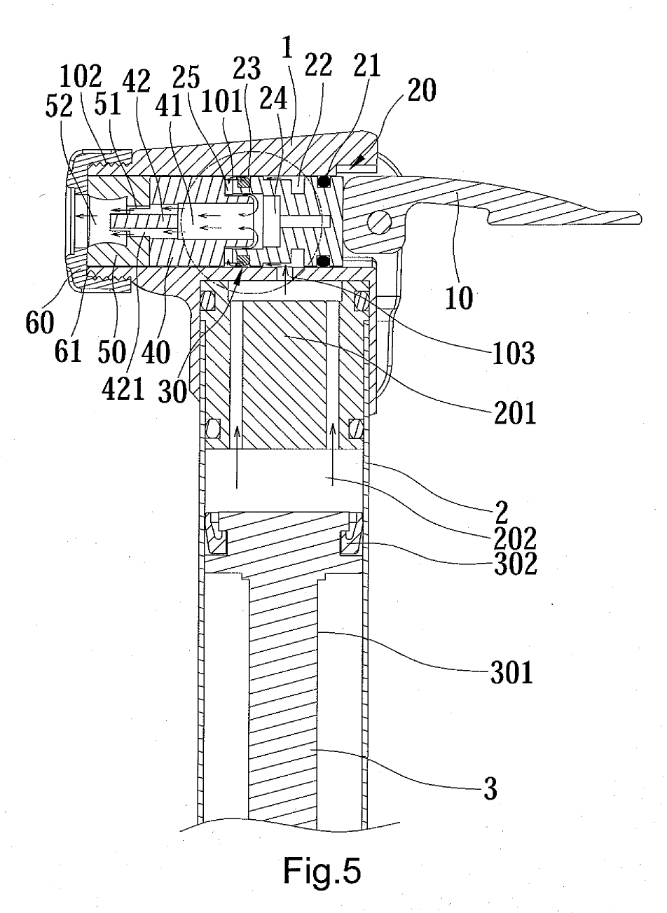

In pumping the air through a valve (not shown), the lever 10 is pivoted to a position seen in FIG. 5, the air is pumped by reciprocatingly moving the inflating member 3 within the cylindrical body 2, and the air is pumped from the cylindrical body 2 to the pump head 1 through the valve 201 and the air-inlet hole 103. The air is thereafter pumped into the recessed portion 22 of the plunger 20. The air is prevented from passing through the sealing member 21 and is allowed to flow pass the first anti-backflow member 30. The air is thereafter directed to the cavity 24 through the plurality of indentations 25, and is thereafter pumped through the bore 41, the second first hole 51, the second hole 52 of the seal gasket 50, and the cap 60 at last. While the air flows pass the first anti-backflow member 30, the fin 32 is compressed toward the body 31 by the air. However, if the first anti-backflow member 30 is mounted on the plunger 20 with the fin 32 extending towards the recessed portion 24, the air will be prevented from flowing through the first anti-backflow member 30. Furthermore, the inflating member 3 may include a second anti-backflow member 302 adapted for preventing leakage of air during the draw stroke of the inflating member 3.

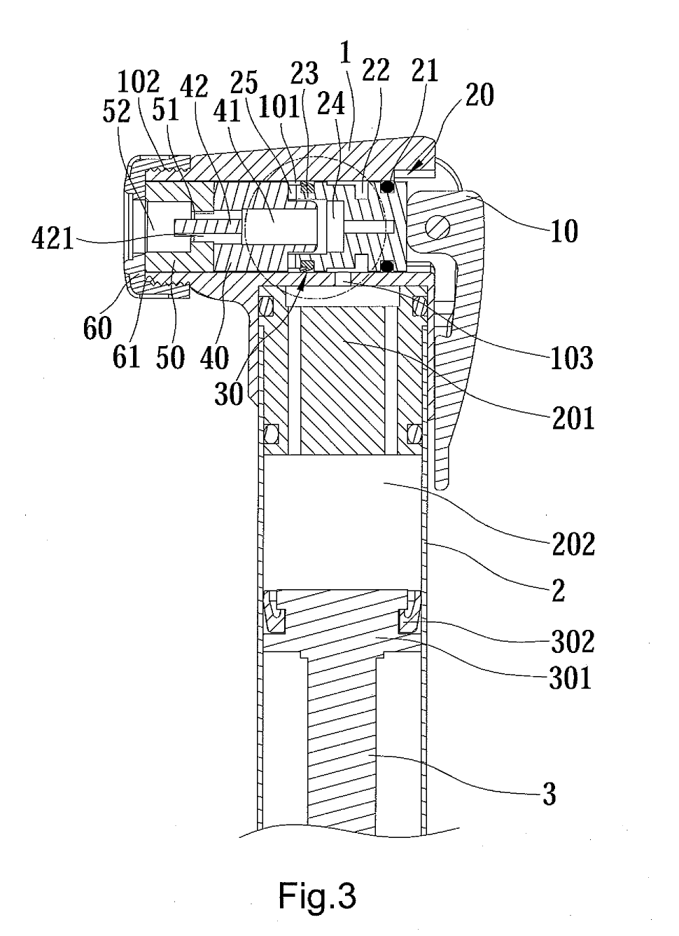

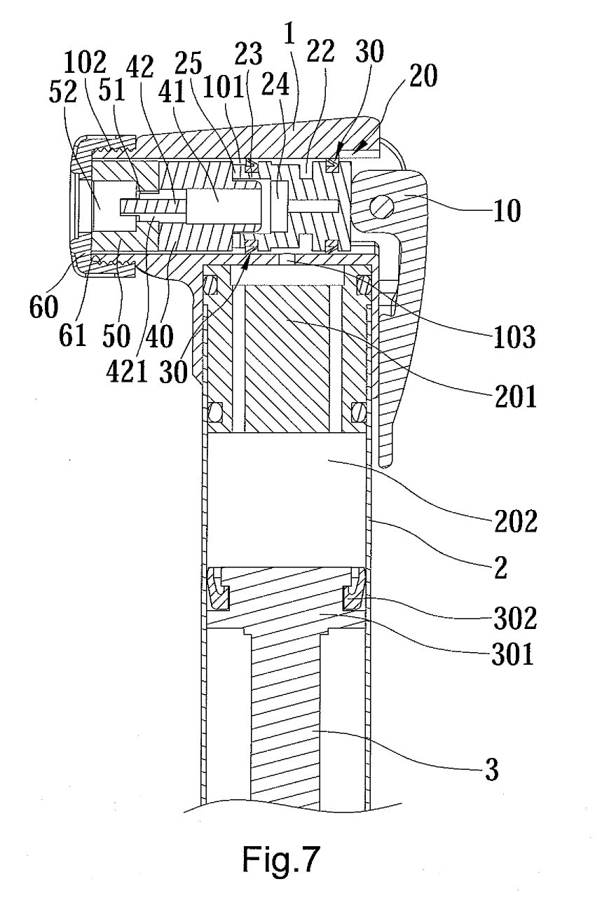

FIG. 7 is another embodiment similar to that of FIG. 3, except that the sealing member 21 is replaced with a first anti-backflow member 30. The first anti-backflow member 30 is mounted to the plunger 20 with the fin 32 extending towards the recessed portion 24. Furthermore, the compartment 101 of the pump head 1 is allowed to have a greater tolerance margin by virtue of a good sealing effect provided by the first anti-backflow members 30.

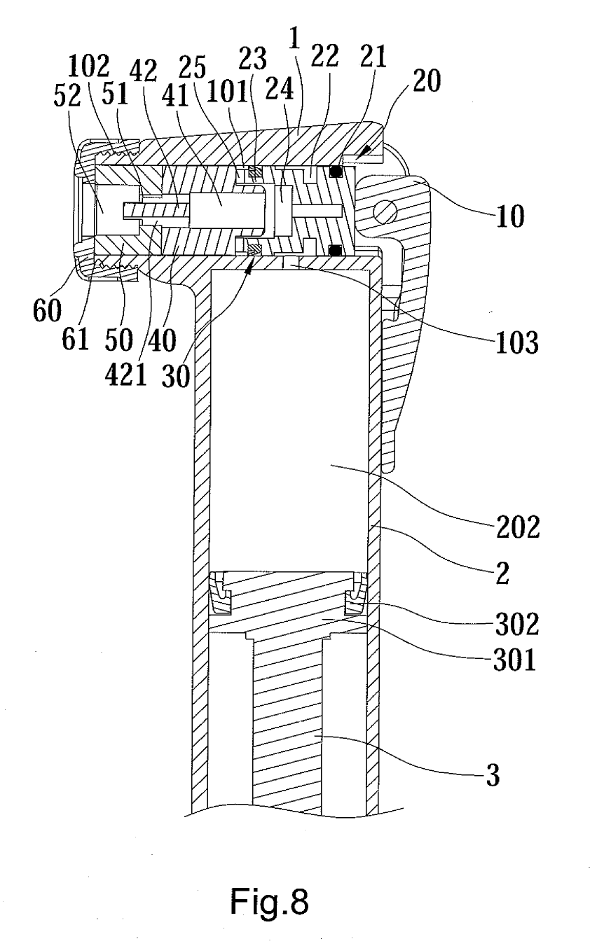

FIG. 8 is yet another embodiment similar to that of FIG. 3, except that the valve 201 is omitted and the pump head 1 and the cylindrical body 2 are made into one piece.

In view of the forgoing, one advantage of the pump head 1 in accordance with the present invention is the provision of the first anti-backflow member 30 that is adapted to prevent leakage of the pumped air from happening.

Another advantage of this invention is the provision of the first anti-backflow member 30 that is adapted to allow a greater tolerance margin for manufacturing the pump head 1 and easy installation thereof.

Yet another advantage of this invention is the provision of the first anti-backflow member 30 that is adapted to allow the cost of manufacturing the pump head 1 to be cut down.

While the specific embodiments have been illustrated and described, numerous modifications come to mind without significantly departing from the spirit of invention and the scope of invention is only limited by the scope of accompanying claims.

What is claimed is:

1. A pump head with improved structure comprising:
a lever pivotally mounted thereto;
a plunger disposed therein, with said plunger including a recessed portion formed around the outer periphery thereof with said plunger including a sealing member receivable at the outer periphery thereof for preventing air from passing therethrough;
a first anti-backflow member mounted on the outer periphery of the plunger for allowing a flow of the air in one direction;
an air induction member resting on said plunger in the longitudinal direction of said plunger;
a seal gasket resting on said air induction member in the longitudinal direction of said air induction member; and
a cap mounted thereto for enclosing said plunger, first anti-backflow member, air induction member and seal gasket in the pump head.

2. A pump head with improved structure as claimed in claim 1 wherein said first anti-backflow member includes a body adapted for mounting on the outer periphery of said plunger and a fin projecting circumferentially around and inclinedly outward from said body, with said fin being compressible toward said body for allowing a flow of the air therethrough.

3. A pump head with improved structure as claimed in claim 1 further includes a first anti-backflow member, with said sealing member being replaceable with said first anti-backflow member.

4. A pump head with improved structure as claimed in claim 1 wherein said sealing member is an O-ring.

5. A pump head with improved structure as claimed in claim 1 includes a compartment for receiving therein said plunger, air induction member and seal gasket.

6. A pump head with improved structure as claimed in claim 1 wherein said plunger includes an air inlet end having a plurality of indentations formed thereon.

7. A pump head with improved structure as claimed in claim 1 wherein said plunger includes a hole extending longitudinally therein, with said hole being receivable by said air induction member.

8. A pump head with improved structure as claimed in claim 1 wherein said seal gasket is made of resilient material such that the seal gasket is deformable by a pressing force actuated by said lever.

9. A pump head with improved structure as claimed in claim 1 further includes a threaded portion and said cap includes a threaded portion whereby said pump head engages said cap in a complement manner.

10. A pump head with improved structure as claimed in claim 1 further includes a cylindrical body connected thereto and an inflating member receivable in the cylindrical body, with said inflating member reciprocatingly moveable within the cylindrical body such that air is pumped from said cylindrical body to said pump head.

11. A pump head with improved structure as claimed in claim 10 wherein the pump head and said cylindrical body are made into two pieces, and with said cylindrical body including a valve disposed therein.

12. A pump head with improved structure as claimed in claim 10 wherein the pump head and said cylindrical body are made into one piece.

13. A pump head with improved structure as claimed in claim 10 wherein said inflating member includes an inflating valve formed thereon for enabling the air to be pumped into said cylindrical body.

14. A pump head with improved structure as claimed in claim 13 wherein said inflating member includes a second anti-backflow member for allowing a flow of the air in one direction.
